(19) United States
(12) Patent Application Publication
(10) Pub. No.: US 2006/0150780 A1
(43) Pub. Date: Jul. 13, 2006

(54) Tool for removing screws with damaged heads

(76) Inventor: Mark Chen, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/031,043

(22) Filed: Jan. 10, 2005

(51) Int. Cl. B25B 13/50; B26B 11/00

(52) U.S. Cl. 81/53.2; 7/158

(57) ABSTRACT

This artistic creation relates to a tool for removing screws with damaged heads. The tool comprises of a screw-removing section and a hold section. The screw-removing section extends a central drill involving a tip and composite angles, so as to remove the broken screws with even heads and avoid incline in operating. Moreover, the sunken relief surfaces of the screw-removing section form scraping edges with strong stress resistance. Some recesses on the scraping surfaces enhance resistance to dig into the heads of deformed screws and are apt to remove the broken screws. More specifically, this invention relates to such a bit especially adapted for use in a power drill running in a counter-clockwise direction.

### FIELD OF THE INVENTION

This invention relates to a tool for removing screws with damaged heads. More specifically, this invention relates to a single-piece tool adapting to install in the chuck of a counter-clockwise rotating drill to remove broken screws and the like.

### BACKGROUND OF THE INVENTION

U.S. Pat. No. 6,742,416, issued Jun. 1, 2004 in the name of Bergamo; Peter J. and assigned to Alden Corporation, disclose bit for removing damaged screws. This bit has an axis and a tip end with an obtuse angle. There are multiple scraping surfaces, each facing counter-clockwise into a longitudinal recess in the tip end. Each scraping surface has a scraping edge at an angle of about 55.degree. to 70.degree. to the axis. Behind each scraping surface the outer surface of the tip end curves down to a rearward edge adjacent another of the longitudinal recesses, the rearward edges each being disposed at a sharper angle to the axis than the scraping edge so that there is some relief, allowing the scraping edge to be more pronounced and enhance its ability to dig into the metal of a deformed screw at points removed from the axis to get a good purchase on the screw.

The fragmentary perspective view of the bit 1 of the previous invention is as shown FIG. 1. The tip 11 of the bit comprises two longitudinal recesses 14 bounded by on one side a longitudinal scraping surface 13 facing in the counter-clockwise direction and having a scraping edge 12, which is preferably a straight line extending from the periphery of the bit to the axis. Generally perpendicular to the surfaces 13 and a transition surface is a longitudinal boundary surface 15, which faces clockwise and which has a rearward edge which also is a straight line from periphery to axis of the bit. Next, there is a generally quarter-conical relief surface.

A second embodiment of the invention is shown in FIG. 2. The bit 2 has an axis and a tip end, which comes to a point 21. At diametrically opposite positions the tip end is formed with recesses 24. The recesses each are defined by a planar counter-clockwise-facing scraping surface 23 having a scraping edge 22.

The two scraping edges 12, 22 of the two previous embodiments are at an angle of about 55.degree. to 70.degree. to the axis. The scraping surfaces 13, 23 connect with the recesses 14, 24 with an acute angle. This previous invention cannot stand larger resistance from the damaged heads of the screws in operation and easily makes flaws on the bit. This previous invention is also only applied to the Philips screws and the like.

There has been a need for a device to remove screws, the heads of which have been damaged by rounding out the Philips screw cross recess or ripping out the side of the slot of a regular screw. Also, the screw head may have been covered by paint so that the recess or slot is no longer pronounced enough to get a good purchase on it by a screwdriver.

In such a case the tool will merely turn in the recess and slip from one position to the next without generating enough torque to remove the screw. Typical of this problem are Phillips head and the like, which become damaged and are difficult or impossible to remove with the regular tools designed for this purpose.

Most of the previous tool techniques involve first drilling a hole into a remnant in which the screw head is broken off or missing, and then inserting some form of tool which engages the drilled hole thereby allowing the remnant to be rotated out of its bore. However in many cases, the screw head remains attached to the screw, but the screw head is damaged when attempting to remove the screw. This problem is particularly acute when a screw head has a symmetrical recess adapted to mate with a special tool, which damages the screw head while attempting to remove the screw, so that it can no longer obtain a purchase on the screw head.

### SUMMARY OF THE INVENTION

This invention relates to a tool for removing screws with damaged heads. More specifically, this invention relates to a single-piece tool adapting to install in the chuck of a counter-clockwise rotating drill to extract screws with damaged screw heads of the type with symmetrical recesses, such as Phillips or other types screw heads. Accordingly, one object of the present invention is to provide an improved tool for removing screws with damaged screw heads.

The present invention relates to an improved product, which is remarkably effective in removing broken screw remnants, and is sufficiently strong to remove the most stubborn remnant from its bore.

The invention, therefore, is a tool for removing broken screws comprising a hold section having a plurality of flat longitudinal surfaces adapting to engage a drill chuck. At one end of the screw-removing there is provided a central drill bit involving a tip and composite angles, so as to remove the broken screws with even heads with no slots or recesses and avoid incline in operating.

Our invention is an optimum tool for removing broken screws and the benefits as follows:

1. Drill a hole as small in diameter as possible so as not to break the wall on the screw,

2. Have a tool as large as possible so as not to break the tool,

3. Drill a hole as shallow as possible and still give enough depth to work. Shallowness is a virtue because the broken part is invariably hard and drilling in it takes valuable time of the mechanic,

4. The screw-removing section of the tool extends a central drill involving a tip and composite angles to remove the screws with even heads with no slots or recesses and avoid incline in operating,

5. The hold section of the tool with a plurality of flat longitudinal surfaces including hexagon, tetragon and triangle. Besides, we design a circular indentation on the hexagonal hold section to engage a power driver chuck,

6. Throughout, the invention will be described in a form suited for removing right-hand screw remnants. It will be understood to those even unskilled in the art that to work with a remnant of left-hand thread, the opposite hand of drill and extractor section from those described herein is used.

### BRIEF DESCRIPTION OF THE DRAWINGS

Other features and objects of the invention will be apparent to those skilled in the art after a study of the following specification, including reference to the appended drawings, all of which show a non-limiting embodiment of the invention. In the drawings:

FIG. 1 is a front view of the tip of the previous invention, U.S. Pat. No. 6,742,416, issued Jun. 1, 2004 in the name of Bergamo; Peter J. and assigned to Alden Corporation;

FIG. 2 is a front view similar to FIG. 1 of a second embodiment of the previous invention, U.S. Pat. No. 6,742,416, issued Jun. 1, 2004 in the name of Bergamo; Peter J. and assigned to Alden Corporation;

FIG. 3 is a perspective view of this invention;

FIG. 4 is a front view of the tip of this invention;

FIG. 5 is FIG. 4 taken 90.degree. apart around the periphery of the bit;

FIG. 6 is a top view of the point of this invention;

FIG. 7 is an elevation view partly in section of a bit embodying this invention installed in a power driver chuck and engaging a screw in the process being removed.

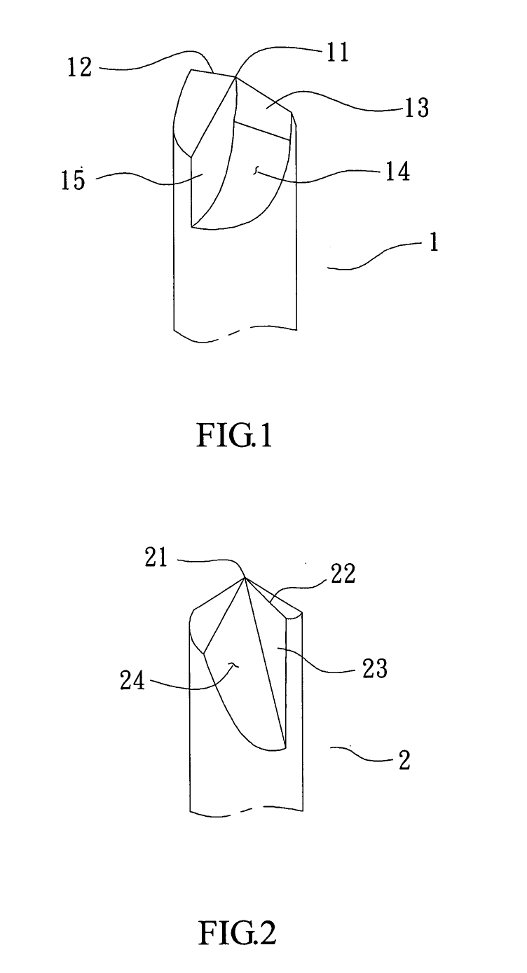

### DETAILED DESCRIPTION OF THE PREFERRED EMBODIMENT

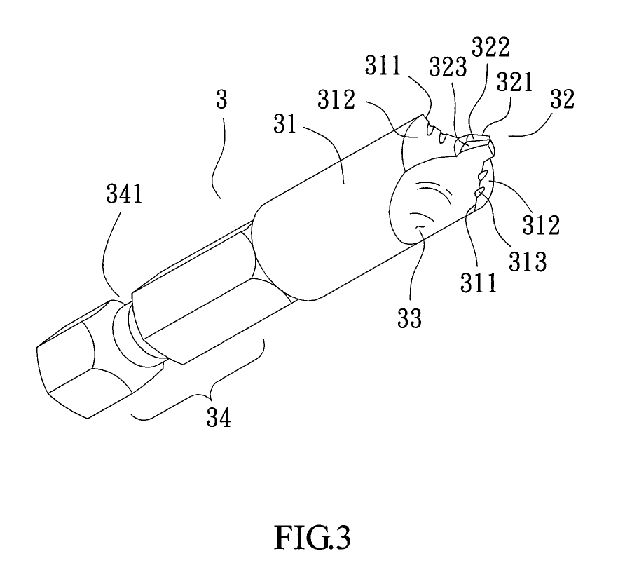

This invention is shown in perspective in FIG. 3. The tool 3 comprises a screw-removing section 31, a central drill 32, a plurality of transition surfaces 33 and a hold section 34. Detail each element of the tool 3 as follows:

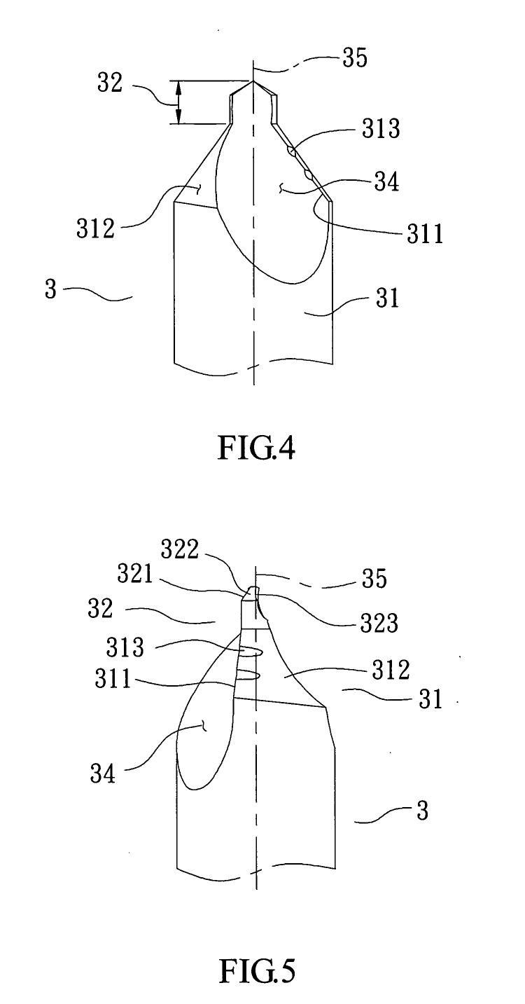

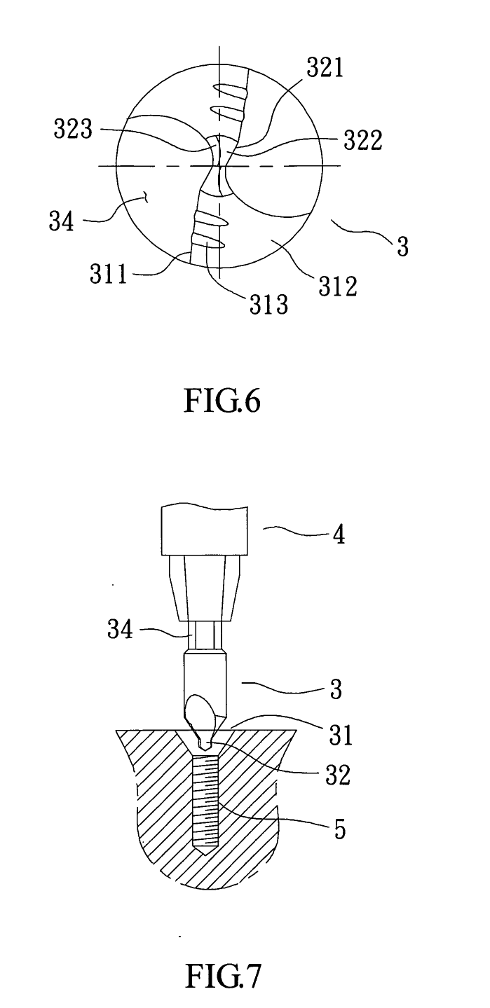

The central drill 32 with a certain length extends from the screw-removing section 31 and connects with a plurality of transition surfaces 33 and they form scraping edges 311, 321. The two scraping edges 311, 321 of the screw-removing section 31 are made at an angle larger than 70.degree. to the axis 35 respectively as shown in FIG. 4 and FIG. 5. There's a plurality of small recesses 313 on the scraping surface 312, which drops down rearward. Such recesses 313 slightly inclines outward and don't extend to the distal of the scraping surface 312 as shown to FIG. 3 to FIG. 6.

The transition surfaces 33 are smoothly sunken relief surface and tilt in a left-hand direction and just make the left-hand scraping edges 311, 321 made by the screw-removing section 31 and the central drill 32. The transition surfaces 33 tilt in a right-hand direction is to extract the left-hand screws.

The hold section 34 directly is located at the distal end of the tool 3 and its profile can be cylindrical or polygonal portion. The polygonal portion can involve hexagonal, tetragonal and triangular form. The area on the distal end of the hold section 34 is necked down at hollow ring 341 to help locate the tool in the chuck as shown in FIG. 3.

A tool 3 is shown in elevation in FIG. 7. The tool 3 may be smoothly cylindrical or even hexagonal shape for its entire length. It is shown held in the chuck of a driver 4 by its hexagonal stem of the hold section 34. The tip is shown engaging the damaged head of a screw 5, which is screwed into a block of the example shown, although it could be a self-tapping metal screw. If the thread of the screw 5 is in a right-hand direction, we adjust the driver in a reverse direction and use slight force to make the tool dig into the damaged head of the screw 5 and then extract the screw 5 in a left-hand direction.

Due to the characteristic of this invention is a central drill 32 which can apply to the even head of the screw 5 and without pre-drilling process. Above all, the central drill 32 has composite angles to keep the drilling in a stable situation.

On the screw-removing section 31 the opposite scraping edges 311, 321 drop down to rearward and a plurality of small recesses 313 on the scraping edges. When drilling, the small recesses 313 can produce resistance to enhance the force for removing the screw 5 quickly. The small recesses 313 with slight incline and an outward direction don't extend to the distal end of the scraping surface 312.

Further variations in the invention are possible. For instance, the bit may be formed with three recesses and three scraping surfaces instead of the two diametrically opposed recesses and two scraping surfaces as described. The sides of the bit may be smooth and cylindrical as shown in the embodiments or hexagonal. Thus, while the invention has been shown in limited embodiments, it is not so limited but is of a scope defined by the following claim language which may be broadened by an extension of the right to exclude others from making, using or selling the invention as is appropriate under the doctrine of equivalents.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded with the broadest interpretation so as to encompass all such modifications and similar structure.

What is claimed is:

1. For removing screws with damaged heads, a tool comprises:
a. A screw-removing section extending a central drill from its top end and connects with transition surfaces to form scraping edges on the screw-removing section; the opposite scraping edges are downward and rearward and produce scraping surfaces,
b. A central drill connecting with a screw-removing section; the top end of the central drill drops down rearward and forms scraping surfaces,
c. A transition surface being sunken relief surface and it connects the screw-removing section and central drill,
d. A hold section directly located at the distal end of the tool to help locate the tool in the chuck.

2. A tool as claimed in claim 1, wherein the angle of the screw-removing section to the axis is larger than 70.degree.

3. A tool as claimed in claim 1, wherein the scraping edges of the screw-removing section drop down rearward to form the scraping surfaces with small recesses, which slightly slant to the outside.

4. A tool as claimed in claim 1, wherein the scraping edges of the screw-removing section drops down rearward to form the scraping surfaces with small recesses which slightly slant to the outside and don't extend to the distal end of the scraping surfaces.

5. A tool as claimed in claim 1, wherein the scraping edges of the screw-removing section drops down rearward to form the scraping surfaces with small recesses.

6. A tool as claimed in claim 1, wherein the scraping edges of the screw-removing section drop down rearward to form the scraping surfaces with a plurality of small recesses.

7. A tool as claimed in claim 1, wherein the scraping edges of the screw-removing section drop down rearward to form the scraping surfaces with a plurality of small recesses, which slightly slant to the outside.

8. A tool as claimed in claim 1, wherein the scraping edges of the screw-removing section drop down rearward to form the scraping surfaces with a plurality of small recesses which slightly slant to the outside and don't extend to the distal end of the scraping surfaces.

9. A tool as claimed in claim 1, wherein the central drill takes a dip to form the scraping surfaces while the more incline and rearward scraping surface produce the structure, being the point of the composite angles of the top end of the central drill.

10. A tool as claimed in claim 1, wherein the A transition surface is sunken relief surface which in a left-hand incline direction.

11. A tool as claimed in claim 1, wherein the hold section is cylindrical in cross-section directly located at the distal end of the tool.

12. A tool as claimed in claim 1, wherein the hold section is polygonal in cross-section directly located at the distal end of the tool.

13. A tool as claimed in claim 1, wherein the hold section is triangular in cross-section directly located at the distal end of the tool.

14. A tool as claimed in claim 1, wherein the hold section is tetragonal in cross-section directly located at the distal end of the tool.

15. A tool as claimed in claim 1, wherein the hold section is hexagonal in cross-section directly located at the distal end of the tool.

16. A tool as claimed in claim 1, wherein the hold section is hexagonal in cross-section directly located at the distal end of the tool and a hollow ring on the hold section.
